(19) United States
(12) Patent Application Publication
(10) Pub. No.: US 2010/0291469 A1
(43) Pub. Date: Nov. 18, 2010

(54) FUEL CELL

(76) Inventors: Yumiko TAKIZAWA, Yokohama-shi (JP); Jun MOMMA, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/783,364

(22) Filed: May 19, 2010

Related U.S. Application Data
(63) Continuation of application No. PCT/JP2008/070515, filed on Nov. 11, 2008.

(30) Foreign Application Priority Data
Nov. 20, 2007 (JP) 2007-300782

(51) Int. Cl. H01M 8/10

(52) U.S. Cl. 429/483

(57) ABSTRACT

According to one embodiment, a fuel cell includes a plurality of planar membrane electrode assemblies each produced by integrating a fuel electrode, an oxidizer electrode and an electrolyte membrane sandwiched between the fuel electrode and the oxidizer electrode, and a polyhedral package frame having plural planes which are disposed in a non-planar arrangement and support the plurality of membrane electrode assemblies so as to surround these membrane electrode assemblies.

### CROSS REFERENCE TO RELATED APPLICATIONS

This is a Continuation Application of PCT Application No. PCT/JP2008/070515, filed Nov. 11, 2008, which was published under PCT Article 21(2) in Japanese.

This application is based upon and claims the benefit of priority from Japanese Patent Application No. 2007-300782, filed Nov. 20, 2007; the entire contents of which are incorporated herein by reference.

### FIELD

Embodiments described herein relate generally to a direct methanol fuel cell effective for the operation of portable electronic devices.

### BACKGROUND

Various miniaturized electronic devices such as personal computers and portable telephones have been recently developed along with the development of semiconductor technologies and an attempt is currently made to use fuel cells as the power sources of these miniaturized devices. The fuel cell has the advantages that it can generate electricity only by supplying fuel and an oxidizer and can also generate electricity continuously by replenishing and exchanging only fuel. For this reason, the fuel cell is a very advantageous system for the operation of portable electronic devices if it can be miniaturized. Particularly, a direct methanol fuel cell (DMFC) can be miniaturized because it uses methanol having a high energy density as the fuel and current can be drawn directly from methanol on the electrode catalyst. Also, because the fuel can be handled more easily than hydrogen gas fuel, the direct methanol fuel cell is regarded as a promising power source for miniature electronic devices and expected to be put to practical use as the most suitable power source for codeless portable electronic devices such as portable telephones, portable audios, portable game machines and notebook personal computers.

In the meantime, the direct methanol fuel cell is reduced in the potential of a unit cell generated between a pair of anode and cathode in the generation of electricity, causing a lack of the power voltage required for operating devices. It is therefore necessary to adopt the so-called multi-electrode structure in which plural pairs of anodes/cathodes are connected in series to compensate for the lack of the power voltage. However, the area occupied by these plural pairs of anodes/cathodes is increased, resulting in the production of a large-sized battery, if these cathodes/anodes are arranged on one plane to connect these cathodes/anodes in series.

JP-A 1997-129258 (KOKAI) and JP-A 2005-353571 (KOKAI) respectively propose a multi-electrode fuel cell in which a membrane-electrode assembly (MEA) containing plural pairs of anodes/cathodes is disposed in a ring form to miniaturize a fuel cell to be used as a portable device power source.

However, because these conventional fuel cells are made to have a ring form as a whole and therefore tend to roll, they lack in a sense of stability. Also, because in the ring fuel cell, the both ends thereof are opened as the opening of a fuel supply passage, this part cannot be utilized for the generation of electricity and it is difficult to increase the power per unit volume. There is an idea in regard to a ring cell extended in the direction of the major axis to increase the output. However, if the length of the cell becomes large, not only is this contrary to the intention to miniaturize the cell, but also the cell tends to roll more easily, leading to a lack in a sense of stability.

Embodiments have been made to solve the above problem and it is an object of the embodiments to provide a small-sized fuel cell which exhibits a high power and is superior in long-term stability.

A fuel cell comprising: a plurality of planar membrane electrode assemblies each comprising a fuel electrode, an oxidizer electrode and an electrolyte membrane sandwiched between the fuel electrode and the oxidizer electrode; and a polyhedral package frame having plural planes which are disposed in a non-planar arrangement and support said plurality of membrane electrode assemblies so as to surround these membrane electrode assemblies.

The fuel cell according to the embodiment, wherein ventilation holes which supply an oxidizer to the oxidizer electrode are opened at each of surfaces of the package frame that face the membrane electrode assemblies.

In addition, the ventilation holes are preferably opened at surfaces of the package frame except for a bottom surface thereof. This is because the bottom surface of the package frame is in contact with, for example, a floor so that the bottom surfaces of many cells substantially fail or are limited in the supply of an oxidizer (air), which prevents or suppresses the progress of a cathode reaction on the oxidizer electrode side. As mentioned above, the structure in which only one surface (bottom surface) is made to be a blind patch having no ventilation hole has the advantage that the upper and lower sides of a cell are easily distinguished. However, because this is a structural problem concerning only a difference in setting method (handling on the user side), ventilation holes may be formed on the entire surface before use in the case of a shape, such as a regular polygonal form, having an indistinctive bottom.

The fuel cell according to the embodiment, further comprising: fuel supply passages which supply fuel to the fuel electrodes of said plurality of membrane electrode assemblies; a plurality of connecting members each of which electrically connects the oxidizer electrode in one of two adjacent membrane electrode assemblies and the fuel electrode in another of the two adjacent membrane electrode assemblies; and output leads connected to both ends of a current collecting circuit formed of the connecting members and the electrodes to draw power generated in the membrane electrode assemblies.

In the embodiment, each of the membrane electrode assemblies preferably has substantially the same area. This is because almost the same power is output from each surface and therefore, not only is the output to the inverter stabilized but also no overload is applied, leading to a reduction in the variation of temperature caused by local heating. As mentioned above, the polyhedrons each having surfaces of the same area include regular polyhedrons. As these regular polyhedrons, for example, a regular tetrahedron, regular hexahedron, regular octahedron, regular dodecahedron, regular icosahedron or stellate regular dodecahedron as shown in FIGS. 5A, 5B, 5C, 5E, 5F and 5G, respectively, may be used. Moreover, in the present invention, the package frame may be a cubic or polygonal prismatic solid. As the polygonal prismatic solid, for example, a regular hexagonal prismatic solid, regular triangular solid, regular pentagonal prismatic solid or stellate 5/2 prismatic solid as shown in FIGS. 1, 5D, 5H and 5J, respectively, may be used.

In the present invention, all of these plural membrane electrode assemblies may be connected in series by connecting members as shown in FIGS. 4, 6, 7, 8A and 9. If they are all connected in series, high voltage can be obtained. Also, as shown in FIG. 8B, the fuel cell of the present invention may comprise a first current collecting circuit in which parts of these plural membrane electrode assemblies are connected in series by connecting members and a second current collecting circuit in which other parts of the membrane electrode assemblies are connected in series by connecting members and which is connected in parallel to the first current collecting circuit. When the power generating part is divided into plural parts and these plural parts are connected in parallel to each other, large current can be obtained.

### BRIEF DESCRIPTION OF THE DRAWINGS

FIG. 1 is a schematic perspective view showing a fuel cell according to an embodiment.

FIG. 2 is an internal perspective and sectional view schematically showing a fuel supply mechanism used in a fuel cell according to the embodiment.

FIG. 3 is a structural block diagram schematically showing another fuel supply mechanism.

FIG. 4 is a development diagram showing a fuel cell according to an embodiment.

FIG. 5A is an external appearance diagram schematically showing a multi-electrode fuel cell having a non-planar form.

FIG. 5B is an external appearance diagram schematically showing a multi-electrode fuel cell having a non-planar form.

FIG. 5C is an external appearance diagram schematically showing a multi-electrode fuel cell having a non-planar form.

FIG. 5D is an external appearance diagram schematically showing a multi-electrode fuel cell having a non-planar form.

FIG. 5E is an external appearance diagram schematically showing a multi-electrode fuel cell having a non-planar form.

FIG. 5F is an external appearance diagram schematically showing a multi-electrode fuel cell having a non-planar form.

FIG. 5G is an external appearance diagram schematically showing a multi-electrode fuel cell having a non-planar form.

FIG. 5H is an external appearance diagram schematically showing a multi-electrode fuel cell having a non-planar form.

FIG. 5J is an external appearance diagram schematically showing a multi-electrode fuel cell having a non-planar form.

FIG. 6 is a development diagram showing a fuel cell according to other embodiment.

FIG. 7 is a development diagram showing a fuel cell according to other embodiment.

FIG. 8A is a development diagram showing a fuel cell (seven series) according to other embodiment.

FIG. 8B is a development diagram showing a fuel cell (two parallel and three series) according to other embodiment.

FIG. 9 is a development diagram showing a fuel cell according to other embodiment.

### DETAILED DESCRIPTION

In general, according to one embodiment will be explained with reference to the drawings.

### First Embodiment

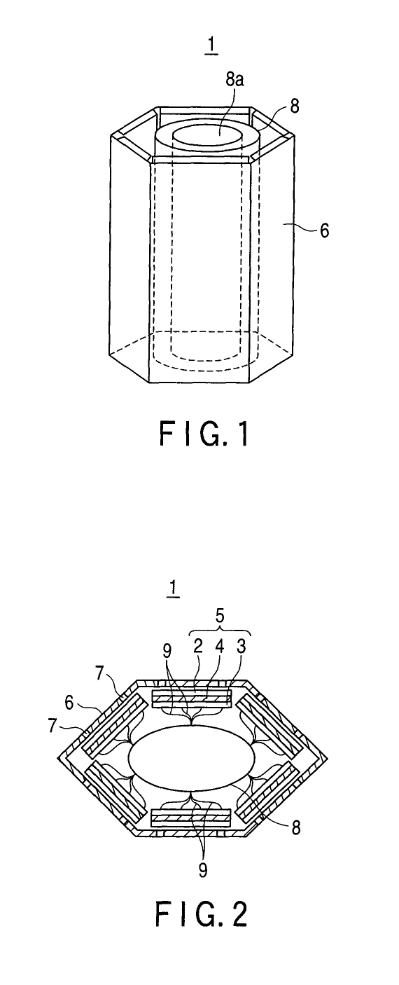

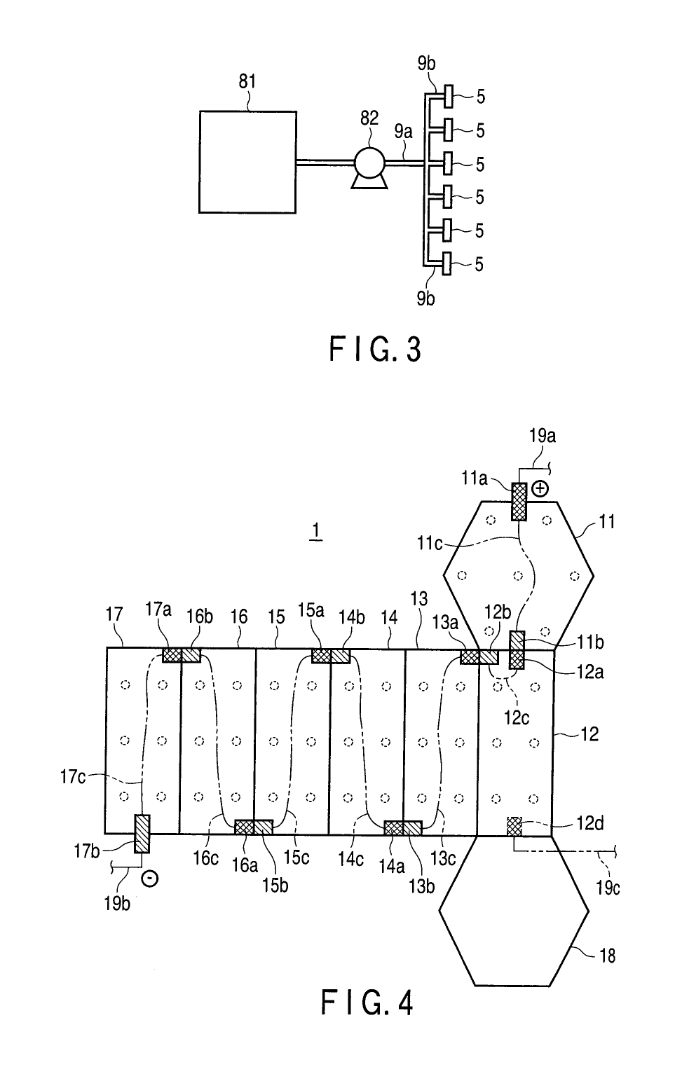

A fuel cell according to a first embodiment will be explained with reference to FIGS. 1 to 4. The outside of a fuel cell 1 in this embodiment is, as shown in FIGS. 1 and 2, covered with a package frame 6 having a hexagonal prismatic form and a cell structure which generates and outputs electricity as a direct methanol fuel cell (DMFC) is contained in the package frame 1. The cell structure is constituted of plural membrane electrode assemblies 5 fabricated into a hexagonal prismatic form and the membrane electrode assemblies 5 adjacent to each other are connected by connecting members 11c to 17c which will be explained later. A fuel tank 8 is accommodated in the cell structure. The fuel tank 8 serves to receive liquid fuel supplied from a fuel injection port 8a and to distribute and supply liquid fuel (methanol solution) to each membrane electrode assembly 5 through branched plural fuel supply passages 9. The fuel tank 8 may be an exchange type cartridge which can be mounted or dismounted with ease.

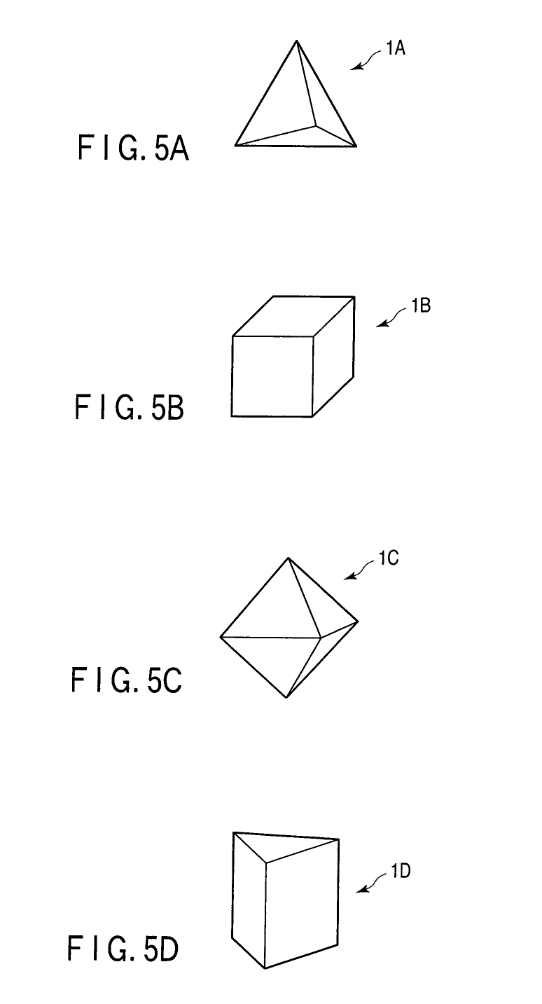

The fuel supply system may be either a passive system in which fuel is transported from the fuel tank 8 by only utilizing a capillary phenomenon of the fuel supply passage 9 as shown in FIG. 2 or a semi-passive system in which an ultra-micro pump 82 is attached to a fuel tank 81 to transport fuel through a major passage 9a and a branched passage 9b as shown in FIG. 3. In the semi-passive system fuel cell, the fuel supplied to each membrane electrode assembly 5 from the fuel tank 81 is used for a power generating reaction, after which the fuel is neither circulated nor returned to the fuel tank 81. The semi-passive system fuel cell is different from the conventional active system fuel cell because fuel is not circulated. Therefore, the semi-passive system gives no difficulty in the miniaturization of the cell. The pump 82 and the fuel tank 81 may be installed outside though they are preferably built in the system. Although the type of the pump 82 is not particularly limited, an electro-osmosis pump (EO pump), rotary pump (rotary vane pump), diaphragm pump, shear pump or the like is preferably used from the viewpoints of further miniaturization and weight reduction, and capability to feed a small amount of liquid fuel with good controllability. The electro-osmosis pump is produced using a sintered porous body such as silica, giving rise to an electro-osmosis phenomenon. The rotary pump rotates a blade by using a motor to feed a liquid. The diaphragm pump is provided with a diaphragm driven by an electromagnet or piezoelectric ceramics to feed a liquid. The shear pump applies pressure on a part of a flexible fuel passage to feed fuel with shear. Among these pumps, an electro-osmosis pump or a diaphragm pump provided with a piezoelectric ceramics is preferably used from the viewpoint of, for example, driving power and size.

It is also preferable to apply an electro-osmosis pump or a diaphragm pump as the pump 82 in order to feed a liquid in a stable amount. In this case, it is so designed that the operation of the pump 82 is controlled by a control circuit (not shown).

The package frame 6 is a member which functions not only as a cover plate used to cover the external surface of the fuel cell body, but also as a structural material which supports and secures the cell structure and fuel tank 8 (81) contained in the fuel cell. A metal material such as stainless steel is preferably used as the material of the package frame 6 used as a function material like this and also, a polyacetal-based engineering plastic such as a polyoxymethylene is preferably used. Also, a ceramic material excellent in impact resistance may also be used as the package frame 6.

The package frame 6 and the membrane electrode assembly 5 are fastened with a screw and/or secured by edge-caulking processing to thereby integrate the cell structure with the package frame 6. Also, a seal member (for example, an O-ring) (not shown) is installed in an appropriate place inside the cell structure to seal a space between the package frame 6 and the membrane electrode assembly 5 liquid-tightly, so that the liquid fuel contained in the cell is prevented from leaking from the package.

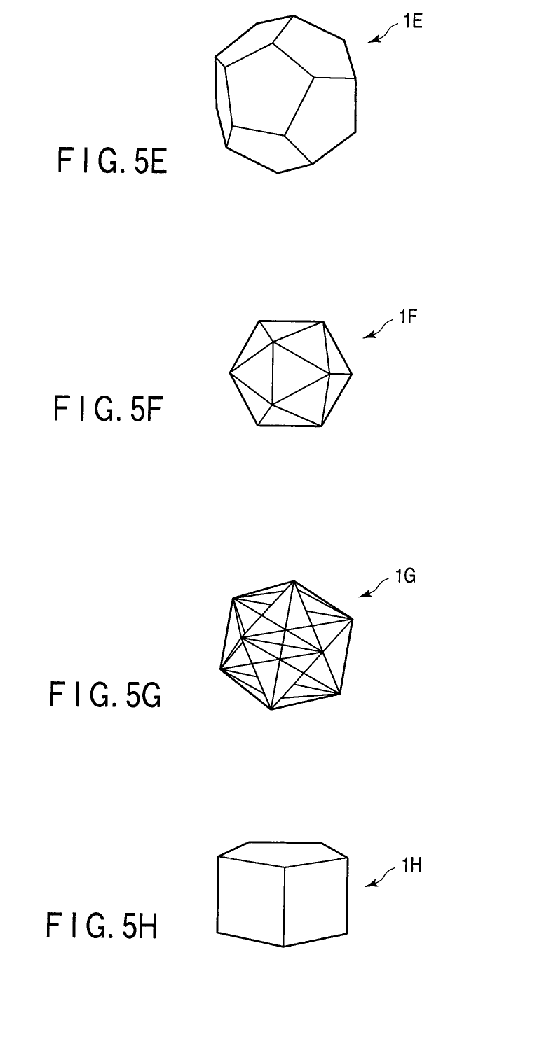

As shown in FIGS. 2 and 4, the fuel cell 1 comprises six membrane electrode assemblies 12 to 17 on its peripheral surface, one membrane electrode assembly 11 on its upper surface and a blind plate on its bottom 18. These membrane electrode assemblies 11 to 17 are respectively structured such that a cathode 2 (oxidizer electrode) 2 is positioned outside and an anode (fuel electrode) 3 is positioned inside. Plural ventilation holes 7 are opened on each surface of the package frame 6 except for the bottom 18 to introduce an oxidizer (air) from the outside. Air is introduced into the inside through these ventilation holes 7, transmits through a humidification plate (not shown) optionally arranged and is supplied to the cathode 2 of the membrane electrode assembly 5 (11 to 17).

The membrane electrode assembly 5 (11 to 17) comprises the cathode 2 consisting essentially of a cathode catalyst layer and a cathode gas diffusing layer, the anode 3 consisting essentially of an anode catalyst layer and an anode gas diffusing layer and a proton-conductive electrolyte membrane 4 supported between the cathode 2 and the anode 3. Examples of the catalyst contained in the cathode catalyst layer and anode catalyst layer may include single metals (for example, Pt, Ru, Rh, Ir, Os and Pd) which are platinum group elements and alloys containing a platinum group element. Pt—Ru highly resistant to methanol and carbon monoxide is preferably used for the anode catalyst and Pt is preferably used for the cathode catalyst, though the catalyst materials are not limited to these materials. Also, either a supported catalyst using a conductive support such as a carbon material or a non-supported catalyst may be used.

The electrolyte membrane 4 serves to transfer protons generated in the anode catalyst layer of the anode 3 to the cathode catalyst layer and is constituted of a material which has no electronic conductivity and can transfer protons. Examples of the material used for the electrolyte membrane 4 include fluororesins having a sulfonic acid group (for example, a perfluorosulfonic acid polymer), hydrocarbon-based resins having a sulfonic acid group, tungstic acid and tungstophosphoric acid. Specifically, the electrolyte membrane 4 is constituted of, for example, a Nafion (trademark) film manufactured by Du Pont, Flemion (trademark) film manufactured by Asahi Glass Co., Ltd. or Aciplex (trademark) film manufactured by Asahi KASEI Corporation. Other than the polyperfluorosulfonic acid-based resin film, a copolymer of a trifluorostyrene derivative, polybenzimidazole film impregnated with phosphoric acid, aromatic polyether ketone sulfonic acid film or aliphatic hydrocarbon-based resin film, which can transfer protons may be used to constitute the electrolyte membrane 4.

The cathode catalyst layer is laminated on the cathode gas diffusing layer and the anode catalyst layer is laminated on the anode gas diffusing layer. The cathode gas diffusing layer serves to supply the oxidizer uniformly to the cathode catalyst layer and also doubles as the current collector of the cathode catalyst layer. On the other hand, the anode gas diffusing layer serves to supply the fuel uniformly to the anode catalyst layer and also doubles as the current collector of the anode catalyst layer.

A vapor-liquid separation film (not shown) optionally disposed serves to transmit only the vaporized component of the liquid fuel (for example, a methanol solution) to be supplied to the membrane electrode assembly from the fuel tank 8 (81) to supply the fuel to the fuel electrode and is of such a nature that it never transmits liquid fuel itself. As the vapor-liquid separation film, a porous film such as a silicon sheet or PTFE film is used. Here, the vaporized component of the liquid fuel means vaporized methanol in the case of using liquid methanol as the liquid fuel and means mixture gas containing the vaporized component of methanol and vaporized component of water in the case of using an aqueous methanol solution as the liquid fuel.

Incidentally, the liquid fuel to be used in the fuel cell of the present invention is preferably a highly concentrated aqueous methanol solution having a fuel concentration exceeding 80 mol % or a pure methanol solution. This is because the output tends to drop when the concentration of fuel is 80 mol % or less, leading to an increase in the frequency of the supply of the fuel.

The liquid fuel is not always limited to the above methanol fuel but may be ethanol fuel such as an aqueous ethanol solution or pure ethanol, propanol fuel such as an aqueous propanol solution or pure propanol, glycol fuel such as an aqueous glycol solution or pure glycol, dimethyl ether, formic acid or other liquid fuels. In any case, liquid fuel according to a fuel cell is used. An aqueous methanol solution having a methanol concentration exceeding 80 mol % or pure methanol solution is particularly preferable.

With regard to the vapor of the liquid fuel supplied to the membrane electrode assembly 5 (11 to 17), the present invention can be applied when a part of the liquid fuel is supplied in a liquid form, though all the liquid fuel may be supplied in a vapor form.

The fuel transported from the fuel tank 8 (81) is supplied to the anode 3 of the membrane electrode assembly 5 (11 to 17). In the membrane electrode assembly 5 (11 to 17), the fuel is diffused in the anode gas diffusing layer and is then supplied to the anode catalyst layer. When methanol fuel is supplied as the liquid fuel, methanol undergoes an internal reforming reaction represented in the following formula (1) in the anode catalyst layer. When pure methanol is used as the methanol fuel, the water produced in the cathode catalyst layer and the water produced in the electrolyte membrane are made to undergo a reaction with methanol, causing the internal reforming reaction of the formula (1). Alternatively, an internal reforming reaction is caused by other reaction mechanism which needs no water.

CH₃OH+H₂→CO₂+6H⁺+6e⁻ (1)

The electrons (e⁻) produced in this reaction are led externally through the current collector and then led to the cathode 2 after they act as electricity to drive portable electronic devices and the like. Also, the protons (H⁺) produced by the internal reforming reaction of the formula (1) are led to the cathode through the electrolyte membrane. Air is supplied as the oxidizer to the cathode. The electrons (e⁻) and protons (H⁺) which have reached the cathode react with oxygen of the air in the cathode catalyst layer according to the following formula (2), resulting in the production of water.

6e⁻+6H⁺+(3/2)O₂→3H₂O (2)

In order to increase the power to be generated in the above power generating reaction of the fuel cell, it is important to run the catalytic reaction smoothly and to add the contribution of all the electrodes of the membrane electrode assemblies 5 (11 to 17) to generation of electricity more efficiently.

Next, the current collecting circuit in the fuel cell 1 will be explained with reference to FIG. 4.

A positive and negative pair of connecting members 11a and 11b is attached to the cathode 3 side and anode side of the membrane electrode assembly 11, respectively. The pair of connecting members 11a and 11b is connected such that the space between these connecting members forms a passage 11c as shown schematically by the internal connecting condition between the cathode and anode of the membrane electrode assembly 11. The cathode side connecting member 11a is connected to a cathode side output lead 19a and further, the output lead 19a is connected to an inverter (not shown). On the other hand, the anode side connecting member 11b is connected to a cathode side connecting member 12a of the membrane electrode assembly 12.

A positive and negative pair of cathode side connecting member 12a and anode side connecting member 12b is attached to the side and corner part of the membrane electrode assembly 12, respectively. The pair of connecting members 12a and 12b is connected such that the space between these connecting members forms a passage 12c as shown schematically by the internal connecting condition between the cathode and anode of the membrane electrode assembly 12. Further, the anode side connecting member 12b is connected to a cathode side connecting member 13a of the membrane electrode assembly 13.

A positive and negative pair of cathode side connecting member 13a and anode side connecting member 13b is attached to the opposite corner parts of the membrane electrode assembly 13, respectively. The pair of connecting members 13a and 13b is connected such that the space between these connecting members forms a passage 13c as shown schematically by the internal connecting condition between the cathode and anode of the membrane electrode assembly 13. Further, the anode side connecting member 13b is connected to a cathode side connecting member 14a of the membrane electrode assembly 14.

Similarly, a positive and negative pair of cathode side connecting member 14a and anode side connecting member 14b is attached to the opposite corner parts of the membrane electrode assembly 14, respectively. The pair of connecting members 14a and 14b is connected such that the space between these connecting members forms a passage 14c as shown schematically by the internal connecting condition between the cathode and anode of the membrane electrode assembly 14. Further, the anode side connecting member 14b is connected to a cathode side connecting member 15a of the membrane electrode assembly 15.

Similarly, a positive and negative pair of cathode side connecting member 15a and anode side connecting member 15b is attached to the opposite corner parts of the membrane electrode assembly 15, respectively. The pair of connecting members 15a and 15b is connected such that the space between these connecting members forms a passage 15c as shown schematically by the internal connecting condition between the cathode and anode of the membrane electrode assembly 15. Further, the anode side connecting member 15b is connected to a cathode side connecting member 16a of the membrane electrode assembly 16.

Similarly, a positive and negative pair of cathode side connecting member 16a and anode side connecting member 16b is attached to the opposite corner parts of the membrane electrode assembly 16, respectively. The pair of connecting members 16a and 16b is connected such that the space between these connecting members forms a passage 16c as shown schematically by the internal connecting condition between the cathode and anode of the membrane electrode assembly 16. Further, the anode side connecting member 16b is connected to a cathode side connecting member 17a of the membrane electrode assembly 17.

Similarly, a positive and negative pair of cathode side connecting member 17a and anode side connecting member 17b is attached to the opposite corner parts of the membrane electrode assembly 17, respectively. The pair of connecting members 17a and 17b is connected such that the space between these connecting members forms a passage 17c as shown schematically by the internal connecting condition between the cathode and anode of the membrane electrode assembly 17. Further, the anode side connecting member 17b is connected to an anode side output lead 19b, which is in turn connected to an inverter (not shown).

A porous layer (for example, a mesh) or a foil body consisting essentially of a metal material such as gold or nickel which is excellent in electric characteristics and chemical stability, or a composite material produced by coating a conductive metal material such as stainless steel (SUS) with a highly conductive metal such as gold may be used for these connecting members 11a, 11b, . . . 17a and 17b. These connecting members 11b and 12a, 12b and 13a, 13b and 14a, 14b and 15a, 15b and 16a and 16b and 17a may be respectively an integrated one.

A cathode current collector and an anode current collector may be disposed on the sides opposite to each catalyst layer of the cathode diffusing layer of the cathode and the anode diffusing layer of the anode in the membrane electrode assembly. The same material as the connecting member may be used for these current collectors.

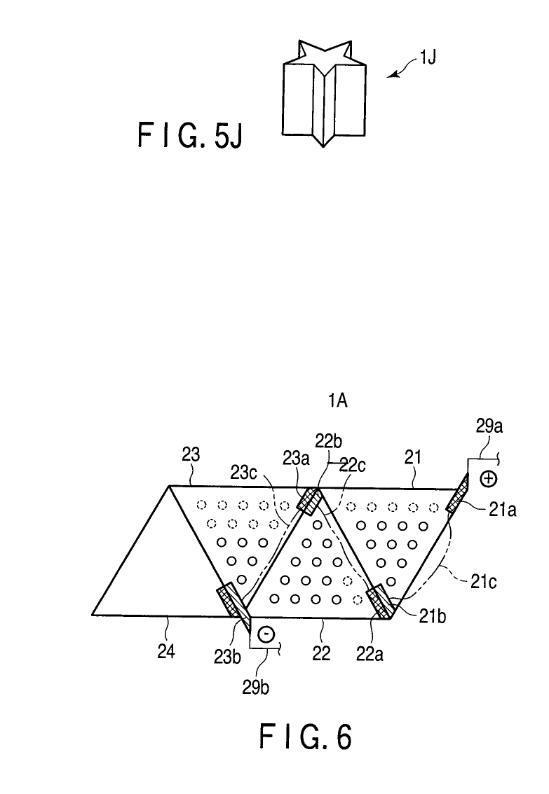

The fuel cell of the present invention may be designed to be a polygonal prismatic solid other than the above hexagonal prismatic solid, and examples of the polygonal prismatic solid include a regular triangular solid, regular pentagonal prismatic solid and stellate 5/2 prismatic solid as shown in FIGS. 5D, 5H and 5J, respectively. Also, the fuel cell of the present invention may be designed to be a regular polyhedron, for example, a regular tetrahedron, regular hexahedron, regular octahedron, regular dodecahedron, regular icosahedron or stellate regular dodecahedron as shown in FIGS. 5A, 5B, 5C, 5E, 5F and 5G, respectively.

### Second Embodiment

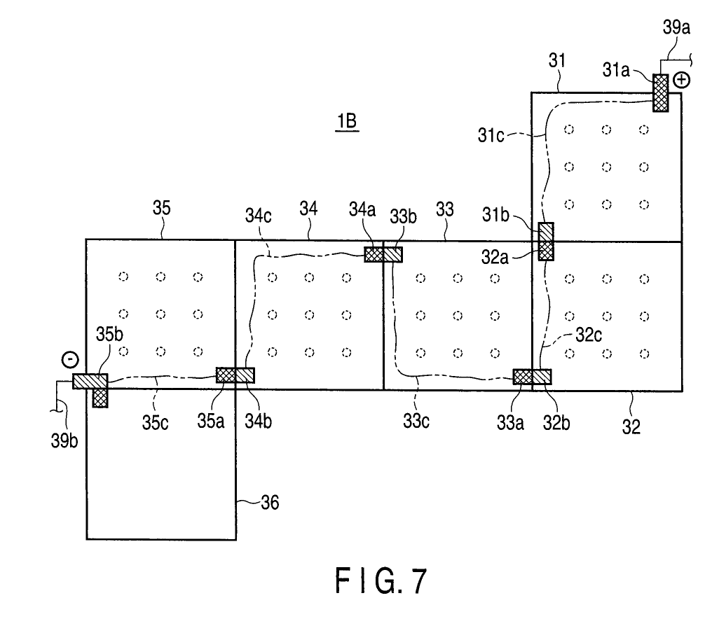

Next, a fuel cell 1A according to a second embodiment will be explained with reference to FIGS. 6 and 5A. In this embodiment, the explanations of the same parts that have been described in the above embodiment will be omitted to avoid unnecessary duplications.

The fuel cell 1A of this embodiment has a regular tetrahedron form. In the current collecting circuit in the fuel cell 1A, a positive and negative pair of cathode side connecting member 21a and anode side connecting member 21b are attached to two corner parts of a membrane electrode assembly 21 having a triangular form, respectively. The pair of connecting members 21a and 21b is connected such that the space between these connecting members forms a passage 21c as shown schematically by the internal connecting condition between the cathode and anode of the membrane electrode assembly 21. The cathode side connecting member 21a is connected to a positive electrode side output lead 29a and further, the output lead 29a is connected to an inverter (not shown). On the other hand, the anode side connecting member 21b is connected to a cathode side connecting member 22a of a membrane electrode assembly 22.

A positive and negative pair of cathode side connecting member 22a and anode side connecting member 22b is attached to two corner parts of the membrane electrode assembly 22, respectively. The pair of connecting members 22a and 22b is connected such that the space between these connecting members forms a passage 22c as shown schematically by the internal connecting condition between the cathode and anode of the membrane electrode assembly 22. Further, the anode side connecting member 22b is connected to a cathode side connecting member 23a of a membrane electrode assembly 23. Further, the anode side connecting member 23b is connected to an anode side output lead 29b, which is in turn connected to an inverter (not shown).

### Third Embodiment

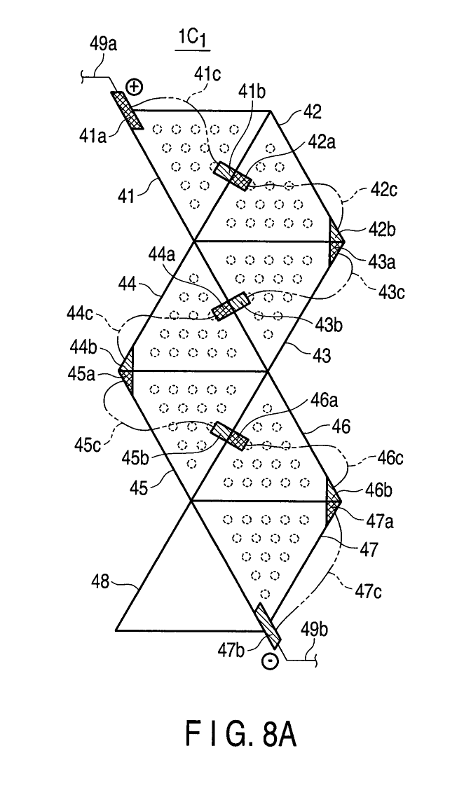

Next, a fuel cell 1B according to a third embodiment will be explained with reference to FIGS. 7 and 5B. In this embodiment, the explanations of the same parts that have been described in the above embodiments will be omitted to avoid unnecessary duplications.

The fuel cell 1B of this embodiment has a regular hexahedron form (cubic form). In the current collecting circuit in the fuel cell 1B, a positive and negative pair of cathode side connecting member 31a and anode side connecting member 31b is attached to two opposite corner parts of a membrane electrode assembly 31 having a square form, respectively. The pair of connecting members 31a and 31b is connected such that the space between these connecting members forms a passage 31c as shown schematically by the internal connecting condition between the cathode and anode of the membrane electrode assembly 31. The cathode side connecting member 31a is connected to a cathode side output lead 39a and further, the output lead 39a is connected to an inverter (not shown). On the other hand, the anode side connecting member 31b is connected to a cathode side connecting member 32a of a membrane electrode assembly 32.

A positive and negative pair of cathode side connecting member 32a and anode side connecting member 32b is attached to the adjacent two corner parts of the membrane electrode assembly 32, respectively. The pair of connecting members 32a and 32b is connected such that the space between these connecting members forms a passage 32c as shown schematically by the internal connecting condition between the cathode and anode of the membrane electrode assembly 32. Further, the anode side connecting member 32b is connected to a cathode side connecting member 33a of a membrane electrode assembly 33.

A positive and negative pair of cathode side connecting member 33a and anode side connecting member 33b is attached to the opposite two corner parts of the membrane electrode assembly 33, respectively. The pair of connecting members 33a and 33b is connected such that the space between these connecting members forms a passage 33c as shown schematically by the internal connecting condition between the cathode and anode of the membrane electrode assembly 33. Further, the anode side connecting member 33b is connected to a cathode side connecting member 34a of a membrane electrode assembly 34.

Similarly, a positive and negative pair of cathode side connecting member 34a and anode side connecting member 34b is attached to the opposite two corner parts of the membrane electrode assembly 34, respectively. The pair of connecting members 34a and 34b is connected such that the space between these connecting members forms a passage 34c as shown schematically by the internal connecting condition between the cathode and anode of the membrane electrode assembly 34. Further, the anode side connecting member 34b is connected to a cathode side connecting member 35a of a membrane electrode assembly 35.

Similarly, a positive and negative pair of cathode side connecting member 35a and anode side connecting member 35b is attached to the adjacent two corner parts of the membrane electrode assembly 35, respectively. The pair of connecting members 35a and 35b is connected such that the space between these connecting members forms a passage 35c as shown schematically by the internal connecting condition between the cathode and anode of the membrane electrode assembly 35. Further, the anode side connecting member 35b is connected to an anode side output lead 39b, which is in turn connected to an inverter (not shown).

### Fourth Embodiment

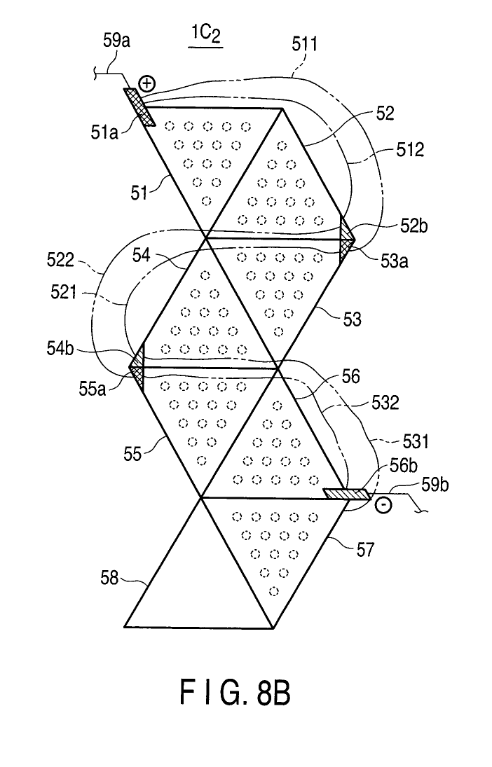

Next, a fuel cell 1C₁ according to a fourth embodiment will be explained with reference to FIGS. 8A and 5C. In this embodiment, the explanations of the same parts that have been described in the above embodiments will be omitted to avoid unnecessary duplications.

The fuel cell 1C₁ of this embodiment has a regular octahedron form. In the current collecting circuit in the fuel cell 1C₁, a positive and negative pair of cathode side connecting member 41a and anode side connecting member 41b is attached to the corner part and the center of the side of a membrane electrode assembly having a triangular form, respectively. The pair of connecting members 41a and 41b is connected such that the space between these connecting members forms a passage 41c as shown schematically by the internal connecting condition between the cathode and anode of a membrane electrode assembly 41. The cathode side connecting member 41a is connected to a cathode side output lead 49a and further, the output lead 49a is connected to an inverter (not shown). On the other hand, the anode side connecting member 41b is connected to a cathode side connecting member 42a of a membrane electrode assembly 42.

A positive and negative pair of cathode side connecting member 42a and anode side connecting member 42b is attached to the adjacent two corner parts of the membrane electrode assembly 42, respectively. The pair of connecting members 42a and 42b is connected such that the space between these connecting members forms a passage 42c as shown schematically by the internal connecting condition between the cathode and anode of the membrane electrode assembly 42. Further, the anode side connecting member 42b is connected to a cathode side connecting member 43a of a membrane electrode assembly 43.

A positive and negative pair of cathode side connecting member 43a and anode side connecting member 43b is attached to the corner part and center of the side of the membrane electrode assembly 43, respectively. The pair of connecting members 43a and 43b is connected such that the space between these connecting members forms a passage 43c as shown schematically by the internal connecting condition between the cathode and anode of the membrane electrode assembly 43. Further, the anode side connecting member 43b is connected to a cathode side connecting member 44a of a membrane electrode assembly 44.

Similarly, a positive and negative pair of cathode side connecting member 44a and anode side connecting member 44b is attached to the corner part and center of the side of the membrane electrode assembly 44, respectively. The pair of connecting members 44a and 44b is connected such that the space between these connecting members forms a passage 44c as shown schematically by the internal connecting condition between the cathode and anode of the membrane electrode assembly 44. Further, the anode side connecting member 44b is connected to a cathode side connecting member 45a of a membrane electrode assembly 45.

Similarly, a positive and negative pair of cathode side connecting member 45a and anode side connecting member 45b is attached to the corner part and center of the side of the membrane electrode assembly 45, respectively. The pair of connecting members 45a and 45b is connected such that the space between these connecting members forms a passage 45c as shown schematically by the internal connecting condition between the cathode and anode of the membrane electrode assembly 45. Further, the anode side connecting member 45b is connected to a cathode side connecting member 46a of a membrane electrode assembly 46.

Similarly, a positive and negative pair of cathode side connecting member 46a and anode side connecting member 46b is attached to the corner part and center of the side of the membrane electrode assembly 46, respectively. The pair of connecting members 46a and 46b is connected such that the space between these connecting members forms a passage 46c as shown schematically by the internal connecting condition between the cathode and anode of the membrane electrode assembly 46. Further, the anode side connecting member 46b is connected to a cathode side connecting member 47a of a membrane electrode assembly 47.

Similarly, a positive and negative pair of cathode side connecting member 47a and anode side connecting member 47b is attached to the corner part and center of the side of the membrane electrode assembly 47, respectively. The pair of connecting members 47a and 47b is connected such that the space between these connecting members forms a passage 47c as shown schematically by the internal connecting condition between the cathode and anode of the membrane electrode assembly 47. Further, the anode side connecting member 47b is connected to an anode side output lead 49b, which is in turn connected to an inverter (not shown).

### Fifth Embodiment

Next, a fuel cell 1C₂ according to a fifth embodiment will be explained with reference to FIGS. 8B and 50. In this embodiment, the explanations of the same parts that have been described in the above embodiments will be omitted to avoid unnecessary duplications.

The fuel cell 1C₂ of this embodiment has a regular octahedron form and is provided with a current collecting circuit constituted of a two parallel circuits each containing three series circuits. In the current collecting circuit in the fuel cell 1C₂, a positive electrode cathode side connecting member 51a is attached to a corner of a triangle membrane electrode assembly and a negative electrode connecting member 52b is attached to a corner of a membrane side electrode assembly 52. The pair of cathode side connecting member 51a and anode connecting member 52b is connected such that the space between these connecting members forms a passage 512 as shown schematically by the internal connecting condition between the cathode and anode of the membrane electrode assemblies 51 and 52. The cathode side connecting member 51a is connected to a cathode side output lead 59a and further, the output lead 59a is connected to an inverter (not shown).

A cathode side connecting member 53a is attached to a corner of a membrane electrode assembly 53 and an anode side connecting member 54b is attached to a corner of a membrane electrode assembly 54. The pair of cathode side connecting member 53a and anode side connecting member 54b is connected such that the space between these connecting members forms a passage 521 as shown schematically by the internal connecting condition between the cathode and anode of the membrane electrode assemblies 53 and 54. Moreover, the positive electrode connecting member 53a is connected to the aforementioned cathode side connecting member 51a through a passage 511 as shown schematically by the internal connecting condition.

A cathode side connecting member 55a is attached to a corner of a membrane electrode assembly 55 and an anode side connecting member 56b is attached to a corner of a membrane electrode assembly 56. The pair of cathode side connecting member 55a and anode side connecting member 56b is connected such that the space between these connecting members forms a passage 532 as shown schematically by the internal connecting condition between the cathode and anode of the membrane electrode assemblies 55 and 56. Moreover, the cathode side connecting member 56 is connected to the aforementioned anode side connecting member 56b through a passage 522 as shown schematically by the internal connecting condition between the cathode and anode of the membrane electrode assemblies 52 and 55. Also, the anode side connecting member 56b is connected to an anode side output lead 59b and further, the output lead 59b is connected to an inverter (not shown).

Ventilation holes 7 are opened at equal intervals on the first to sixth side surfaces 51 to 56. However, no ventilation hole is opened on the bottom surfaces 57 and 58.

In the fuel cell 1C₂ of this embodiment, a first current collecting circuit in which the first, second and fifth membrane electrode assemblies 51, 52 and 55 are connected in series and a second current collecting circuit in which the side surfaces of the third, fourth and sixth membrane electrode assemblies 53, 54 and 56 are connected in series are connected in parallel to the output leads 59a and 59b, respectively, so as to draw the output generated from each current collecting circuit. In this case, the membrane electrode assembly 5 is additionally attached to each of the side surface 57 and bottom surface 58, and current collecting electrodes and connecting terminals are additionally attached to thereby add the bottom surfaces 57 and 58 to the first and second current collecting circuits. In this case, the fuel cell is made to have a structure in which the side surface 57 and the bottom surface 58 are coated with a cover plate 6 having the ventilation holes 7 and a separate stand is used to prevent these ventilation holes from being closed. A two-parallel and four-series structure is thereby obtained, making it possible to raise the voltage to be drawn, resulting in improved generating efficiency.

### Sixth Embodiment

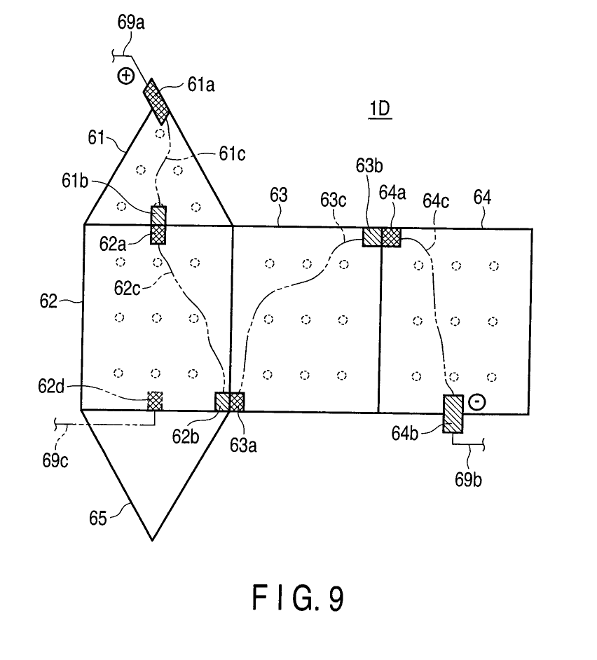

Next, a fuel cell 1D according to a sixth embodiment will be explained with reference to FIGS. 9 and 5D. In this embodiment, the explanations of the same parts that have been described in the above embodiments will be omitted to avoid unnecessary duplications.

The fuel cell 1D of this embodiment has a triangular prism form. In the current collecting circuit in the fuel cell 1D, a positive and negative pair of cathode side connecting member 61a and anode side connecting member 61b is attached to the corner part and center of the side, which are to be on the upper surface, of a membrane electrode assembly 61 having a triangular form, respectively. The pair of connecting members 61a and 61b is connected such that the space between these connecting members forms a passage 61c as shown schematically by the internal connecting condition between the cathode and the anode of the membrane electrode assembly 61. The cathode side connecting member 61a is connected to a cathode side output lead 69a and further, the output lead 69a is connected to an inverter (not shown). On the other hand, the anode side connecting member 61b is connected to a cathode side connecting member 62a, which is to be on the side surface, of the membrane electrode assembly 62.

A positive and negative pair of cathode side connecting member 62a and anode side connecting member 62b is attached to each center of the opposite sides of the membrane electrode assembly 62, respectively. The pair of connecting members 62a and 62b is connected such that the space between these connecting members forms a passage 62c as shown schematically by the internal connecting condition between the cathode and anode of the membrane electrode assembly 62. Further, the anode side connecting member 62b is connected to a cathode side connecting member 63a of a membrane electrode assembly 63.

A positive and negative pair of cathode side connecting member 63a and anode side connecting member 63b is attached to the opposite two corner parts of the membrane electrode assembly 63, respectively. The pair of connecting members 63a and 63b is connected such that the space between these connecting members forms a passage 63c as shown schematically by the internal connecting condition between the cathode and anode of the membrane electrode assembly 63. Further, the anode side connecting member 63b is connected to a cathode side connecting member 64a of a membrane electrode assembly 64.

A positive and negative pair of cathode side connecting member 64a and anode side connecting member 64b is attached to the corner part and center of the side of the membrane electrode assembly 64, respectively. The pair of connecting members 64a and 64b is connected such that the space between these connecting members forms a passage 64c as shown schematically by the internal connecting condition between the cathode and anode of the membrane electrode assembly 64. Further, the anode side connecting member 64b is connected to an anode side output lead 69b and further, the output lead 69b is connected to an inverter (not shown).

According to the present invention, stably generated output reduced in variation can be obtained and it is therefore possible to provide excellent miniature power sources for codeless portable electronic devices such as portable telephones, portable audios, portable game machines and notebook personal computers.

Although the present invention has been described by way of various embodiments, the invention is not limited to the above embodiments and may be embodied by modifying the structural elements without departing from the spirit of the invention. Also, various inventions can be made by proper combinations of plural structural elements disclosed in the above embodiments. For example, several structural elements may be excluded from all structural elements shown in the embodiments. Moreover, the structural elements form different embodiments may be appropriately combined.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fuel cell comprising:
a plurality of planar membrane electrode assemblies each comprising a fuel electrode, an oxidizer electrode and an electrolyte membrane sandwiched between the fuel electrode and the oxidizer electrode; and
a polyhedral package frame having plural planes which are disposed in a non-planar arrangement and support said plurality of membrane electrode assemblies so as to surround these membrane electrode assemblies.

2. The fuel cell according to claim 1, wherein ventilation holes which supply an oxidizer to the oxidizer electrode are opened at each of surfaces of the package frame that face the membrane electrode assemblies.

3. The fuel cell according to claim 2, wherein the ventilation holes are opened at surfaces of the package frame except for a bottom surface thereof.

4. The fuel cell according to claim 1, further comprising:
fuel supply passages which supply fuel to the fuel electrodes of said plurality of membrane electrode assemblies;
a plurality of connecting members each of which electrically connects the oxidizer electrode in one of two adjacent membrane electrode assemblies and the fuel electrode in another of the two adjacent membrane electrode assemblies; and
output leads connected to both ends of a current collecting circuit formed of the connecting members and the electrodes to draw power generated in the membrane electrode assemblies.

5. The fuel cell according to claim 1, wherein areas of the membrane electrode assemblies are substantially the same.

6. The fuel cell according to claim 1, wherein the package frame has a regular polyhedron form.

7. The fuel cell according to claim 1, wherein the package frame has a cubic or polygonal prismatic form.

8. The fuel cell according to claim 4, wherein all of the electrodes in said plurality of membrane electrode assemblies are electrically connected in series by the connecting members.

9. The fuel cell according to claim 4, further comprising:
a first current collecting circuit in which some of the electrodes in said plurality of membrane electrode assemblies are electrically connected in series by the connecting members; and
a second current collecting circuit in which other electrodes in said plurality of membrane electrode assemblies are electrically connected in series by the connecting members and which is connected in parallel to the first current collecting circuit.
